(19) United States
(12) Patent Application Publication
(10) Pub. No.: US 2019/0275625 A1
(43) Pub. Date: Sep. 12, 2019

(54) Gauge

(71) Applicant: Chad Weissenfels, Cashmere, WA (US)

(72) Inventor: Chad Weissenfels, Cashmere, WA (US)

(21) Appl. No.: 15/917,611

(22) Filed: Mar. 10, 2018

(51) Int. Cl. B23Q 9/00; B25F 5/02

(52) U.S. Cl. CPC B23Q 9/0028; B25F 5/003; B25F 5/021

(57) ABSTRACT

A gauge may measure a proper level of exposure for siding installation or another measurement. The gauge may be top mounted onto a nose or upper assembly area of a device, bottom mounted onto a base of a device handle, or side mounted onto a device component, for example, a basket or magazine of a siding gun. The gauge may be adjustable to accommodate different devices such as a nail gun, screw gun, or drill, and allow the device to function while maintaining minimal deflection.

### FIELD

This disclosure relates to tools and, more specifically, to a gauge.

### BACKGROUND

Construction and improvement projects rely on consistency of measurements. For example, siding installation typically entails establishing a first course as a starting point in elevation. Every course has a specific exposure, and courses must be maintained around a building.

Workers balance multiple tasks on site. For example, a worker often uses a measuring device in one hand while using the other hand to mark measurements or to hold material in place before switching out the measuring device for a fastening device. When measurements are inaccurate or material moves out of place, tasks must be repeated, time is wasted, and the project may have unsatisfactory results. Challenges such as these make conventional tools and methods counter-productive and prone to inconsistencies.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The instant application discloses, among other things, a gauge. The gauge may measure a proper level of exposure for siding installation, or another measurement. In one embodiment, the gauge may be top mounted onto a nose or upper assembly area of a siding gun or other device. In another embodiment, the gauge may be bottom mounted onto a device, for example, it may utilize an end cap disposed at a base of a device handle. In yet another embodiment, the gauge may be mounted directly onto a basket or magazine of a siding gun or other device.

The gauge may include hooks for hanging or securing onto a belt, siding, ladder rung, or other structure or object. The gauge may be adjustable to accommodate different devices, allowing the device to function while maintaining minimal deflection. The gauge may increase accuracy, consistency, and efficiency of workers' productivity in the field.

### BRIEF DESCRIPTION OF THE DRAWINGS

FIG. 1 is an exploded view of a gauge, according to one embodiment.

FIG. 2 is a perspective view of Gauge 100 top mounted onto a device.

FIG. 3 is a perspective view of a gauge, according to one embodiment.

FIG. 4 is a bottom perspective view of a gauge, according to one embodiment.

FIG. 5 is a bottom perspective view of a gauge, according to one embodiment.

FIG. 6 is a bottom perspective view of a gauge, according to one embodiment.

FIG. 7 is a side perspective view of a gauge, according to one embodiment.

FIG. 8 is a side view of a gauge, according to one embodiment.

FIG. 9 is a perspective view of a gauge, according to one embodiment.

FIG. 10 is a front view of a gauge, according to one embodiment.

FIG. 11 is a front view of nose mount for a gauge, according to one embodiment.

FIG. 12 is a side view of a nose mount for gauge, according to one embodiment.

FIG. 13 is a front view of an index control key for a gauge, according to one embodiment.

FIG. 14 is a front view of a fence spacer for a gauge, according to one embodiment.

### DETAILED DESCRIPTION

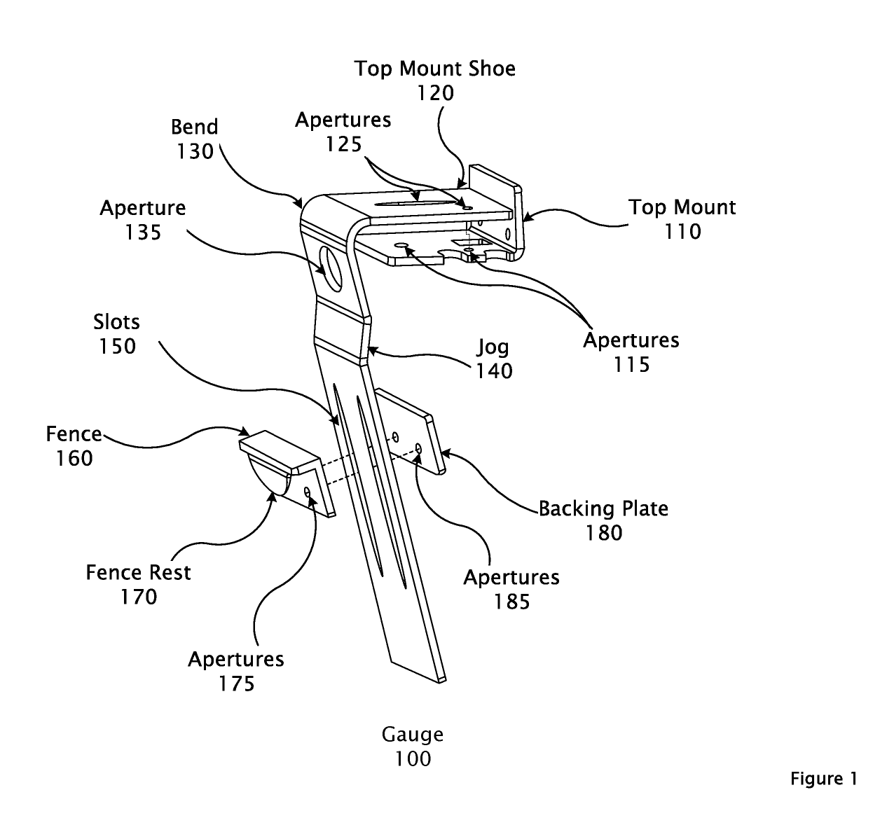

FIG. 1 is an exploded view of a gauge, according to one embodiment. Gauge 100 may include Top Mount 110, which may couple to a nose or upper assembly area of a siding gun or other device. In one embodiment, Top Mount 110 may comprise a bent sheet of material with Apertures 115, 125 through which fastening means may secure Top Mount 110 to Top Mount Shoe 120 or directly to a device.

Top Mount Shoe 120 may comprise an elongated sheet of material having a Bend 130 near a first end where Top Mount Shoe 120 secures to Top Mount 110 or to a device. Top Mount Shoe 120 may have Apertures 115, 125, through which fastening means may secure Top Mount Shoe 120 to Top Mount 110 or to the device. A second end of Top Mount Shoe 120 may extend generally downward from Bend 130. Top Mount Shoe 120 may be disposed in a forward-facing area of a device when the device is held by a user. For example, Top Mount Shoe 120 may be disposed at or near a nose of siding gun or in front of a basket or magazine. In another embodiment, Top Mount 110 and Top Mount Shoe 120 may be fused or comprise a single integral piece, for example, a unibody shoe, mountable onto a device.

Top Mount Shoe 120 may include Aperture 135, which may receive a device component, for example, a nose of a siding gun. Jog 140 may comprise an offset in Top Mount Shoe 120 to allow sufficient space for a device component to function. For example, Jog 140 may comprise an offset in Top Mount Shoe 120 to allow sufficient space for a nose safety on a siding gun to compress, allowing a fastener to release.

Top Mount Shoe 120 may include Slots 150 to receive Fence 160. Slots 150 may comprise one or more elongated openings extending along a length of the second end of Top Mount Shoe 120. Slots 150 may serve as a track upon which Fence 160 may be secured or adjusted along a length of Top Mount Shoe 120. Fence 160 may comprise a guard having a horizontal top edge disposed perpendicular to the second end of Top Mount Shoe 120. In another embodiment, Fence 160 may secure to lateral sides of Top Mount Shoe 120, so as to use the sides as a track or rail. Top Mount Shoe 120, Slots 150, or Fence 160 may include notches, teeth, detents, slides, rails, mounts, brackets, or other fastening or adjustment means.

In top mount embodiments of a gauge, such as Gauge 100, a worker in the field may refer to a distance between Fence 160 and the top of a device component, such as a siding gun nose, to determine a proper nailing site for a piece of siding, for example. Top Mount Shoe 120 or Fence 160 may include calibrated marks in various units, for example, lines or notches to indicate distance. In another embodiment, Top Mount Shoe 120 or Fence 160 may include a level, protractor, laser, magnetic or electronic stud finder or sensor, radio frequency technology 3-D imaging device, or another measuring device.

Fence 160 may include Fence Rest 170 which may allow Gauge 100 to hang on or secure to a belt, tool pouch, piece of siding, ladder rung, gutter, rafter, fencing, or other structure or object, for example. Fence 160 may couple to Top Mount Shoe 120 by fastening means which may pass through Apertures 175 and secure to Backing Plate 180 through Apertures 185, for example.

A person skilled in the art will understand that Gauge 100 or its components may comprise configurations with various attributes such as width, length, height, angle, or orientation, for example, to accommodate different devices, projects, or settings. Gauge 100 may contribute to function or geometry of a device by task and may be modified to conform to such function or geometry of various devices. For example, a manufacturer may integrate perches, bungs, threaded inserts, backing, or other elements onto a device, which may facilitate in securing any part of Gauge 100 onto the device.

Apertures of Gauge 100 may comprise any type of opening, hole, slot, or gap, for example. Fastening means on any part of Gauge 100 may include screws, bolts, nails, pins, knobs, rivets, magnets, latches, levers, cams, knobs, handles, compression or spring-loaded elements, perches, tangs, spring pins, inserts, threaded keys, wedges, shoulder bolts, washers, or nylon fasteners, for example.

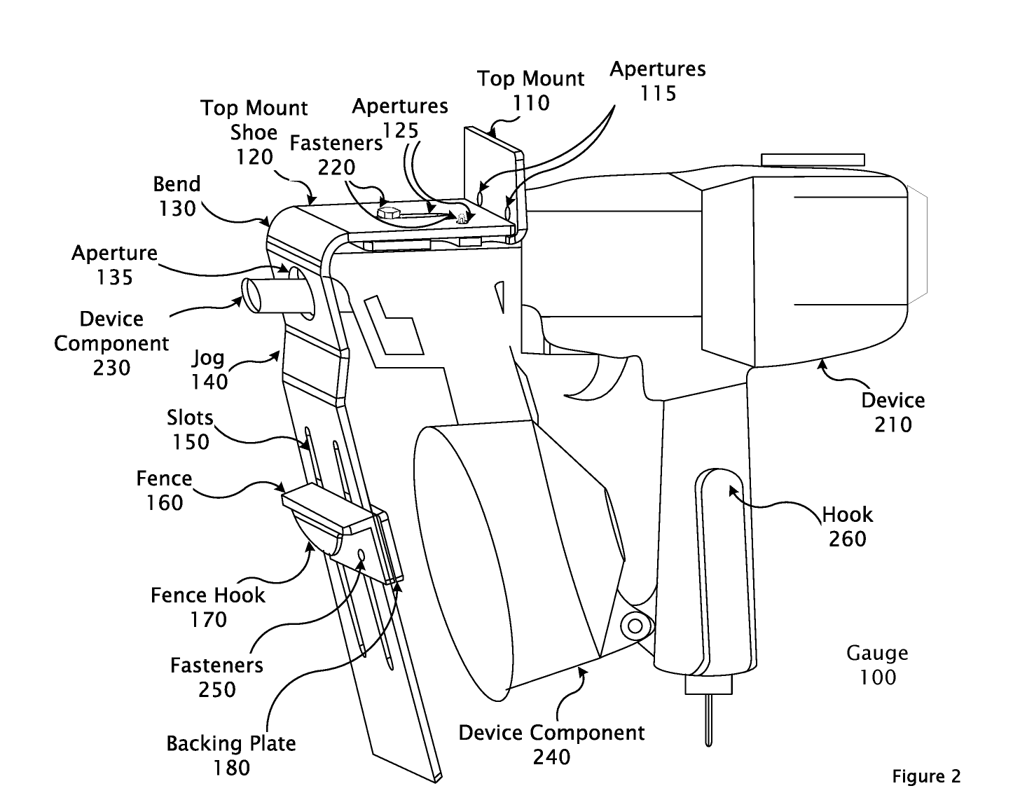

FIG. 2 is a perspective view of Gauge 100 top mounted onto a device. Top Mount 110 may secure to a nose or top assembly area of Device 210, for example, a pneumatic nailer or electric nailer, siding gun, fence gun, roofing gun, staple gun, finish nailer, screw gun, drill, framing gun, finish guns, or another device. Top Mount 110 may include Apertures 125, which may receive fastening means to secure Top Mount 110 to Device 210 or to Top Mount Shoe 120.

Top Mount Shoe 120 may comprise an elongated sheet of material having a Bend 130 near a first end where Top Mount Shoe 120 secures to Top Mount 110. Top Mount Shoe 120 may have Apertures 125 through which Fasteners 220 may secure Top Mount Shoe 120 to Top Mount 110 or to Device 210.

A second end of Top Mount Shoe 120 may generally extend downward from Bend 130. Aperture 135 of Top Mount Shoe 120 may provide an opening through which Device Component 230, for example, a nose of a siding gun, screw gun, or drill, may pass. Top Mount Shoe 120 may be disposed in a forward-facing area of a device when the device is held by a user. For example, Top Mount Shoe 120 may be disposed at or near a nose of siding gun and in front of Device Component 240, for example, a bottom, side, or rear-drop basket or side, top, or rear-loading magazine.

Jog 140 may comprise an offset in Top Mount Shoe 120 to provide clearance for Device Component 230, or another device component, to function. For example, Jog 140 may comprise an offset in Top Mount Shoe 120 to allow clearance for a nose safety on a siding gun to compress, allowing a fastener to release.

Slots 150 of Top Mount Shoe 120 may comprise one or more elongated openings extending along a length of the second end of Top Mount Shoe 120. Slots 150 may receive Fence 160. Slots 150 may serve as a track upon which Fence 160 may be adjusted along a length of Top Mount Shoe 120.

Fence 160 may comprise a guard having a horizontal top edge disposed perpendicular to the second end of Top Mount Shoe 120. Top Mount Shoe 120 or Fence 160 may include calibrated marks. Fence 160 may include Fence Rest 170, which may allow Device 210 to hang on or secure to a structure or object.

Top Mount Shoe 120, Fence 160, or Fence Rest 170 may be disposed at various angles, widths, or projections to accommodate different devices, settings, or projects, for example. In one embodiment, Fence Rest 170 may be flipped in another direction to perform in tandem with Fence 160 in another task. Fence 160 may couple to Top Mount Shoe 120 by Fasteners 250, which may pass through apertures in Fence 160 and secure to Backing Plate 180.

Top Mount Shoe 120 may be operable to be removed, adjusted, or rotated relative to Top Mount 110 or Device 210. For example, Fasteners 220 or Apertures 125 may allow Top Mount Shoe 120 to slide forward and rotate 90 degrees so as to provide clearance for Device Component 240, for example, a rear-drop or bottom-drop basket or magazine, to be opened, reloaded, or closed.

Gauge 100 may include Hook 260, which may allow Gauge 100 to hang or secure to a belt, a tool pouch, a piece of siding, a ladder rung, a gutter, a rafter, fencing, or another structure or object, for example. Hook 260 may be an integral or non-integral part of Gauge 100. Hook 260 may be disposed in any location, for example, at a base of a device handle or the side of a device cylinder. In another embodiment, Hook 260 may disposed on Top Mount 110.

As an example, Gauge 100 may allow a worker to accurately and efficiently determine a proper nailing site for a piece of siding without losing productivity in the field. For example, while utilizing the siding gun, the worker may engage a top edge of Fence 160 against a bottom edge of a first installed piece of siding. The worker may rest a second uninstalled piece of siding on top of the siding gun nose, which may pass through Aperture 135. The worker may hold the second uninstalled piece of siding against a building and operate the siding gun to fasten the second piece of siding to the building, achieving a desired siding exposure. The worker may also refer to the distance between Fence 160 and the nose of the siding gun to mark other nailing sites. A manufacturer or worker may calibrate Fence 160 and adjust it as needed to achieve a desired height for a siding exposure, nailing site, or other attribute.

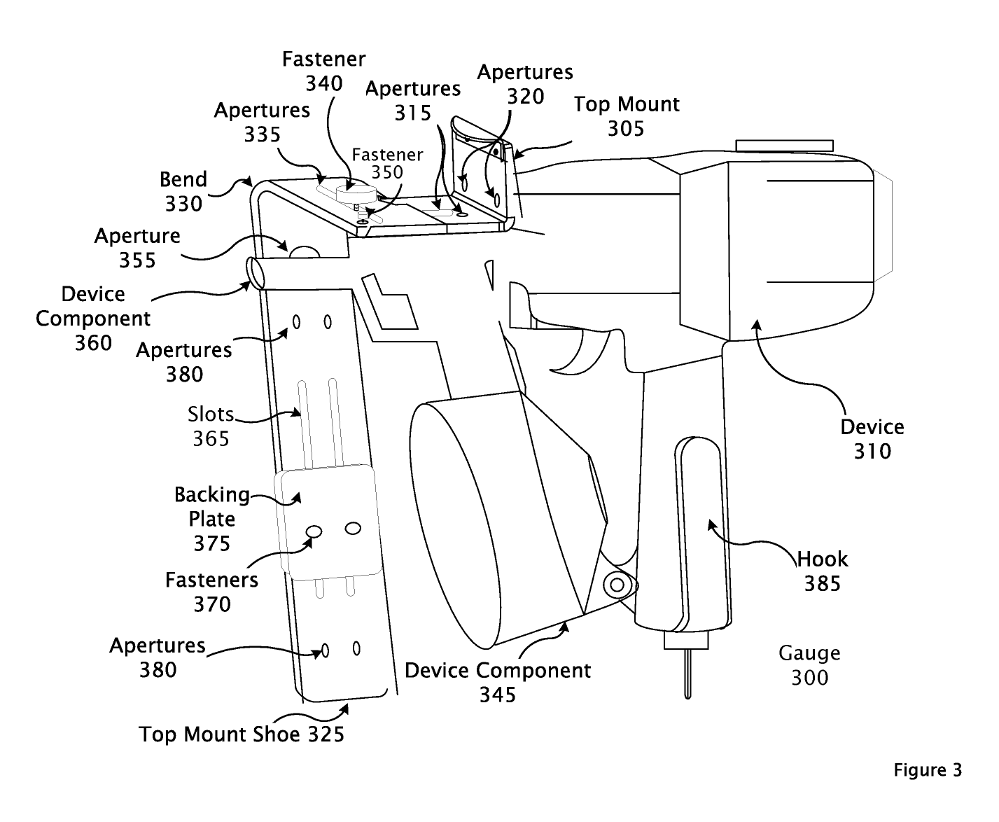

FIG. 3 is a perspective view of a gauge top mounted onto a device, according to one embodiment. Gauge 300 may include Top Mount 305, which may couple to a nose or upper assembly area of Device 310, for example, a siding gun, screw gun, or nailer. Top Mount 305 may include apertures, for example, Apertures 315, 320 through which fasteners may pass to secure Top Mount 305 to Device 310 or to Top Mount Shoe 325.

Top Mount Shoe 325 may comprise an elongated sheet of material having Bend 330 near a first end where Top Mount Shoe 325 secures to Top Mount 305. Top Mount Shoe 325 may have apertures, for example, Apertures 335, through which fastening means may secure Top Mount Shoe 325 to Top Mount 305 or to Device 310.

In one embodiment, Apertures 315 or 335 may include an L-shaped, tick-marked, sloped, angled, or keyholed slot through which Fastener 340, for example, a threaded knob or spring-loaded release, may be disposed or tightened to secure Top Mount Shoe 325 to Top Mount 305 or Device 310. Fastener 340 may be loosened to allow Top Mount Shoe 325 to slide forward or rotate, for example, 90 degrees or another angle, relative to Top Mount 305, with or without fully disconnecting Top Mount Shoe 325 from Top Mount 305 or Device 310. This configuration may provide clearance for Device Component 345, for example, a basket or magazine of a siding gun, to open or close. For example, it may provide easy access for a user to reload fasteners or clear nail jams in Device Component 345. Gauge 300 may also include an aperture to receive Fastener 350, for example, an index pin, to prevent Top Mount Shoe 325 from becoming displaced when Fastener 340 is tightened or from jarring of Gauge 300 while in use. In another embodiment, Top Mount Shoe 325 may be removed, adjusted, or rotated relative by means of a hinge, track, or other adjustment means.

Any apertures or fastening means on Gauge 300 may allow for a secure and adjustable fit of Gauge 300 on Device 310 without impeding function of Device 310 or its components, for example, a button or switch. Top Mount Shoe 325, or other parts of Gauge 300, may also include Apertures 380 for receiving fasteners or other parts.

A second end of Top Mount Shoe 325 may generally extend downward from Bend 330. Aperture 355 may receive a Device Component 360, for example, a nose of a siding gun. Slots 365 may receive a fence which may couple to Top Mount Shoe 325 by Fasteners 370, which may couple to Backing Plate 375. In another embodiment, Backing Plate 375 may be arranged with a single hole when used with a single slot shoe and self-squaring fence.

Gauge 300 may include Hook 385, which may allow Gauge 300 to hang on or secure to a user's belt, for example, or another structure or object. Hook 385 may be disposed at or near a base of a handle of the device, on a side of a device cylinder, or another location.

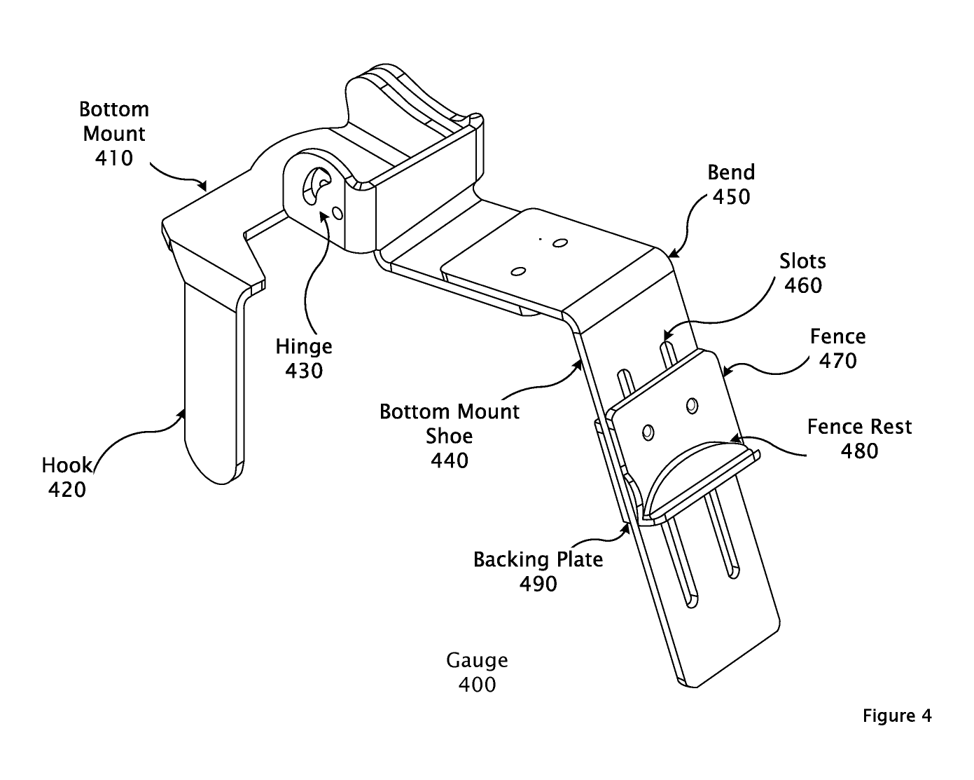

FIG. 4 is a bottom perspective view of a gauge, according to one embodiment. Gauge 400 may comprise a hinged bottom mount operable to secure to a base of a device, for example, at or near a handle or air fitting of a nailer gun. Bottom Mount 410 may include Hook 420 for hanging or securing Gauge 400 onto a structure or object. Bottom Mount 410 may include Hinge 430. Hinge 430 may comprise a flexible or movable joint, pivot, or another mechanism which may allow Gauge 400 to open, close, rotate, swing, or otherwise be adjusted to a geometry or features of a device or its components, for example.

Bottom Mount 410 may couple to Bottom Mount Shoe 440, which may include Bend 450 to accommodate a geometry of a device on which Gauge 400 is mounted. Slots 460 may receive Fence 470, which may be movable along Slots 460. Fence 470 may include Fence Rest 480 for hanging or resting on a structure or object. Fence Rest 480 may provide a stable index when resting against a structure or object. A fastening means may secure Fence 470 to Bottom Mount Shoe 440 and Backing Plate 490. A person skilled in the art will understand that Gauge 400 may include various apertures, fastening means, or other parts to facilitate functionality with various devices, conditions, or settings. In another embodiment, Gauge 400 may comprise a unibody gauge.

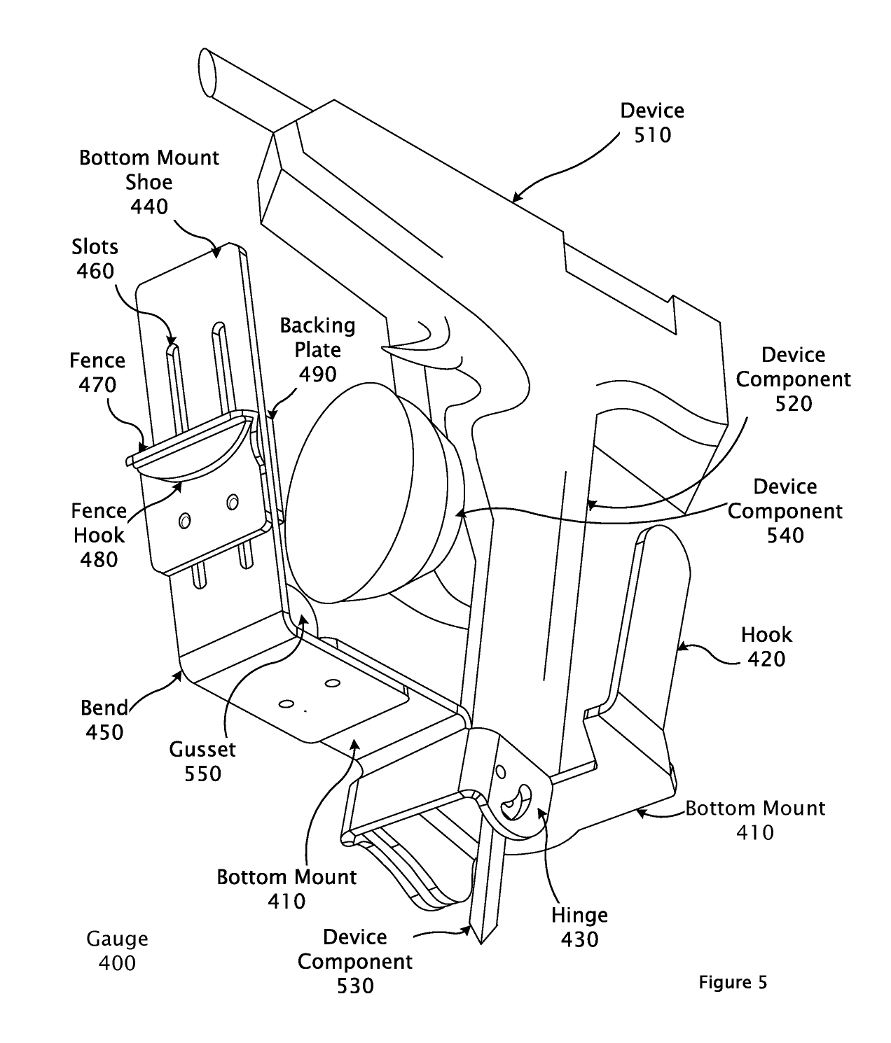

FIG. 5 is a bottom perspective view of a gauge mounted onto a device, according to one embodiment. Gauge 400 may comprise a hinged Bottom Mount 410 operable to secure to a bottom area of a Device 510. For example, it may secure to a base of Device Component 520, such as a nailer gun handle, perch, or cap screw. Bottom Mount 410 may include an aperture to receive Device Component 530, such as an air fitting of a pneumatic nailer or a cord of an electric nailer, for example. Bottom Mount 410 may include Hook 420 for hanging or securing Gauge 400 to a structure or object.

Bottom Mount 410 may couple to Bottom Mount Shoe 440. Bottom Mount 410 may include Hinge 430, which may comprise a flexible or movable joint, pivot, or mechanism which may allow Gauge 400 to open, close, rotate, swing, or otherwise be adjusted to a geometry or features of Device 510 or its components. Bottom Mount Shoe 440 may comprise an elongated sheet of material coupled to Bottom Mount 410 at a first end. A second end of Bottom Mount Shoe 440 may extend generally upward from Bend 450. In one embodiment, Gusset 550 may comprise a bracket configured to strengthen an angle formed by a Bend 450. The second end of Bottom Mount Shoe 440 may be disposed near an outward facing area of Device 510 when the device is held by a user.

Slots 460 may receive Fence 470, which may be movable along Slots 460. Fence 470 may include Fence Rest 480 for hanging or securing onto a structure or object. Fence 470 may couple to Bottom Mount Shoe 440 and Backing Plate 490.

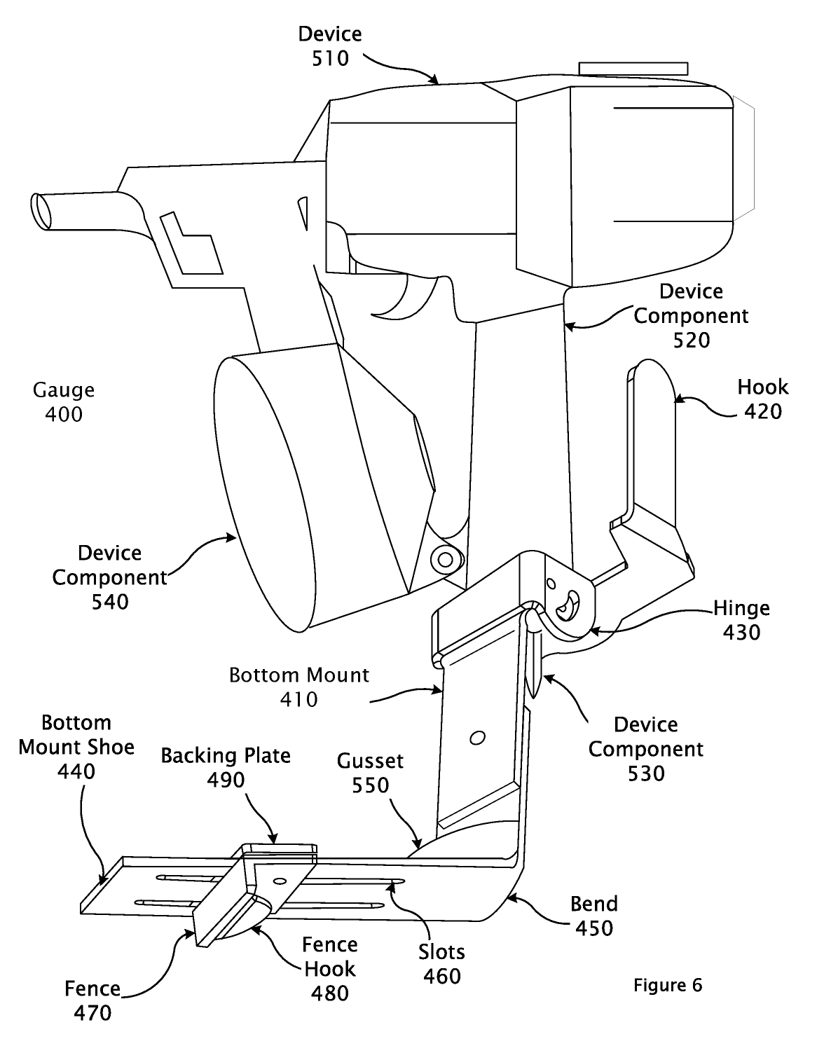

FIG. 6 is a bottom perspective view of a gauge mounted onto a device, according to one embodiment. Gauge 400 may comprise a hinged Bottom Mount 410 operable to secure to a bottom area of a Device 510. For example, it may secure to a base of Device Component 520, such as a nailer gun handle. Bottom Mount 410 may include an aperture to receive Device Component 530, such as an air fitting of a pneumatic nailer or a cord of an electric nailer, for example. Bottom Mount 410 may include Hook 420 for hanging or securing onto a structure or object.

Bottom Mount 410 may couple to Bottom Mount Shoe 440. Bottom Mount 410 may include Hinge 430, which may comprise a flexible or movable joint, pivot, or mechanism which may allow Gauge 400 to open, close, rotate, swing, or otherwise be adjusted to a geometry or features of Device 510 or its components. For example, Hinge 430 may allow Bottom Mount Shoe 440 to rotate downward 90 degrees, or another angle, to provide clearance for Device Component 540, such as a bottom-drop basket or rear-loading magazine.

Bottom Mount Shoe 440 may comprise an elongated sheet of material coupled to Bottom Mount 410 at a first end. A second end of Bottom Mount Shoe 440 may extend generally upward from Bend 450. In one embodiment, Gusset 550 may comprise a bracket configured to strengthen an angle formed by a Bend 450. The second end of Bottom Mount Shoe 440 may be disposed near an outward facing area of Device 510 when the device is held by a user. For example, it may be generally disposed in front of Device Component 540, such as a basket or magazine. This configuration may provide easy access for opening, closing, reloading, or clearing jams, for example.

Slots 460 may receive Fence 470, which may be movable along Slots 460. Fence 470 may include Fence Rest 480 for hanging or securing to a structure or object. Fence 470 may couple to Bottom Mount Shoe 440 and Backing Plate 490.

A person skilled in the art will understand that Gauge 400 may include various apertures, fastening means, or other parts to facilitate functionality of Gauge 400 with various devices, conditions, or settings. In another embodiment, Gauge 400 may comprise a unibody gauge when coupled to device perches, for example.

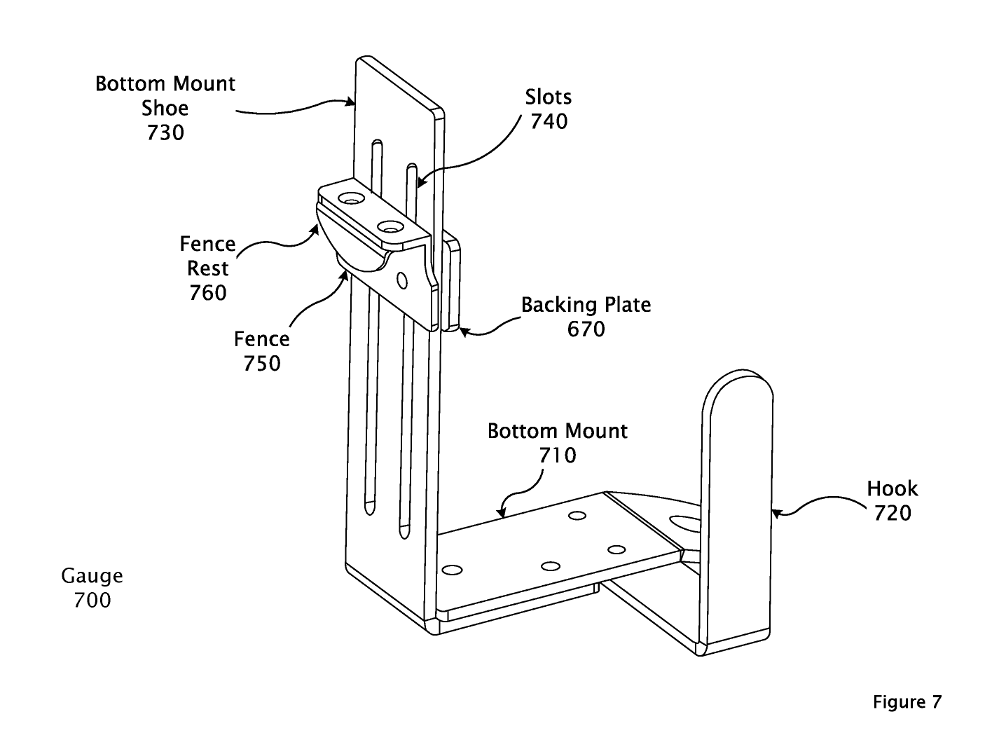

FIG. 7 is a side perspective view of a gauge, according to one embodiment. Gauge 700 may comprise a static Bottom Mount 710 operable to secure to a bottom area of a device. Bottom Mount 710 may include Hook 720 for hanging or securing onto a structure or object. Bottom Mount 710 may couple to Bottom Mount Shoe 730, which may generally extend upward from Bottom Mount 710. Bottom Mount Shoe 730 may include Slots 740 to receive Fence 750. Fence 750 may include Fence Rest 760 for hanging or securing onto a structure or object. Fence 750 may couple to Bottom Mount Shoe 730 by attaching to Backing Plate 670, and may be movable along a length of Slots 740.

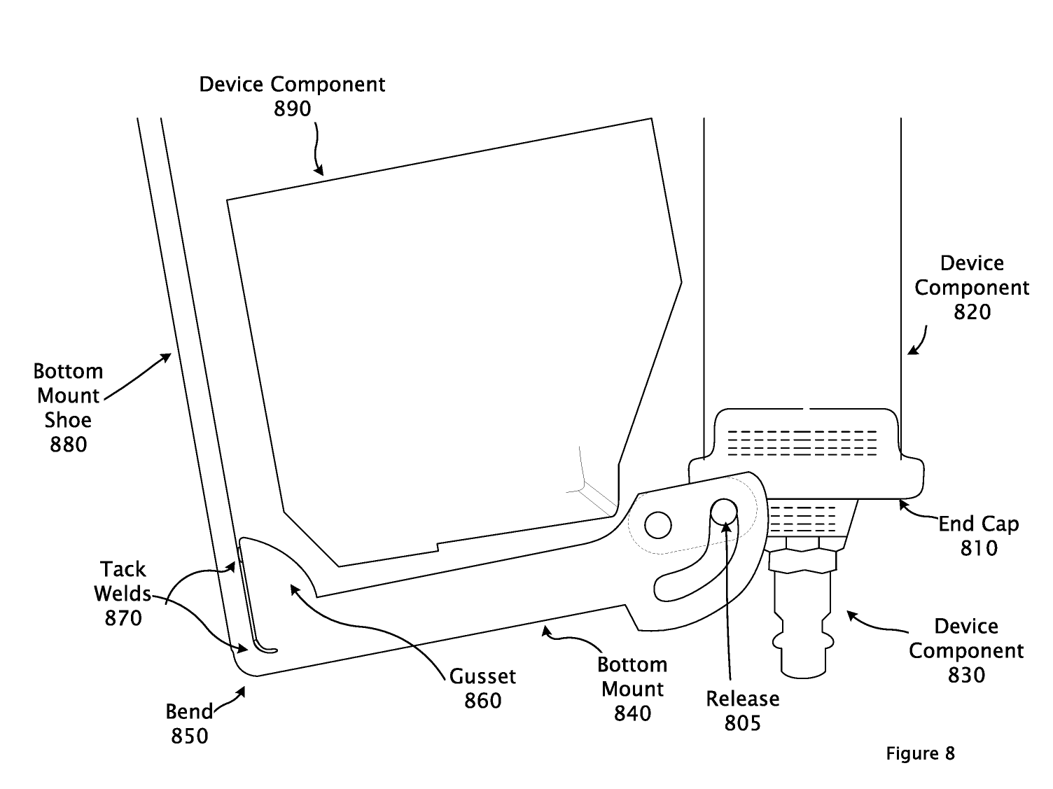

FIG. 8 is a side view of a gauge, according to one embodiment. The gauge may include a device End Cap 810, which may be disposed at a base of Device Component 820, for example, a handle of a nailer gun. End Cap 810 may include an aperture to receive or secure to Device Component 830, for example, an air fitting of a pneumatic nailer or cord of an electric nailer.

End Cap 810 may couple to Bottom Mount 840, which may couple to Bottom Mount Shoe 880. Bottom Mount Shoe 880 may generally extend upward from Bottom Mount 840 at Bend 850. In one embodiment, Gusset 860 may comprise a bracket configured to strengthen an angle formed by Bend 850. Tack Welds 870 may further strengthen the angle. A person skilled in the art will understand that a shoe and mount may comprise a unibody platform or a plurality of parts, for example, in this or another embodiment.

End Cap 810 may have a flat or pitched top to accommodate geometry of a device on which it is mounted. End Cap 810 may accommodate various devices, for example, fixed or hinged models of a gauge.

In one embodiment, Bottom Mount 840 may be operable to open, close, or rotate about an axis or pin on End Cap 810, for example, to provide clearance for Device Component 890, such as a bottom drop basket or magazine.

Release 805 may allow Bottom Mount 840 to be easily released or locked. Release 805 may be, for example, a knob or a spring-loaded quick release.

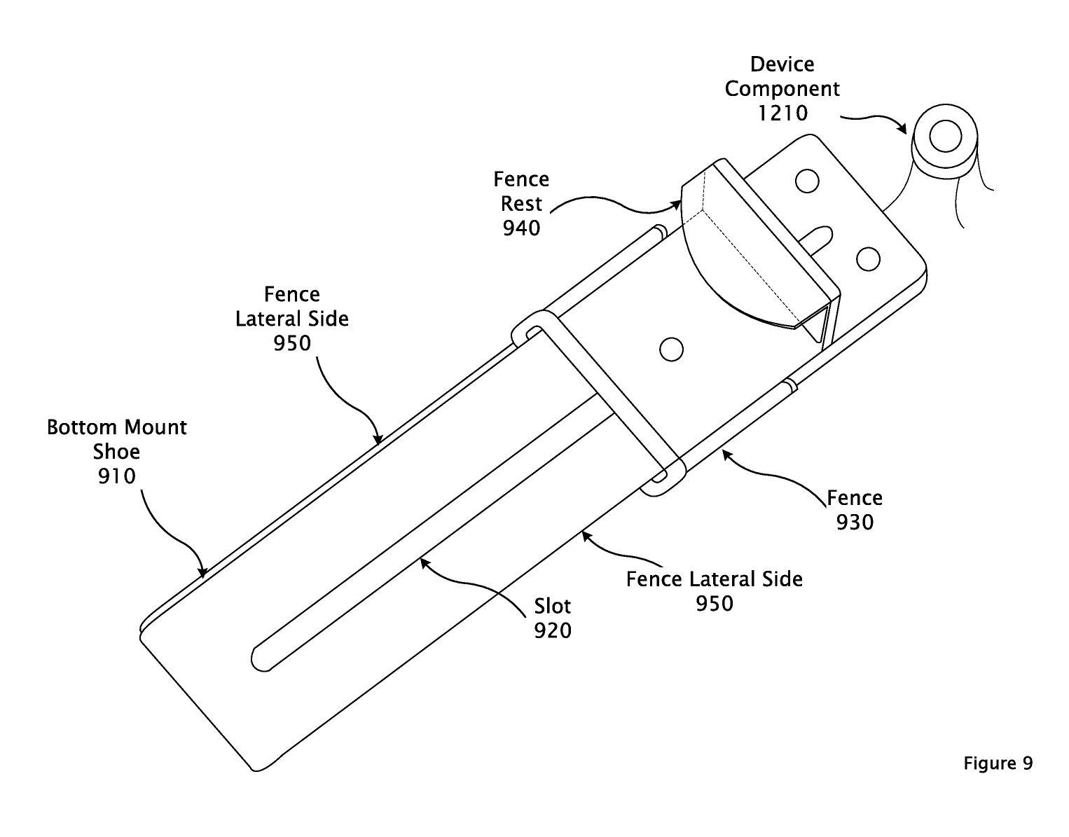

FIG. 9 is a perspective view of a gauge, according to one embodiment. The gauge may include a self-squaring fence. Fence 930 may couple to Bottom Mount Shoe 910 and may secure to a device, providing clearance for Device Component 1210, for example, a nose of a nailer gun. Slot 920 may receive Fence 930, which may be movable along Slot 920. Fence 930 may slide independently of Bottom Mount Shoe 910. Fence Lateral Side 950 may be bent down at its edges or folded down around Bottom Mount Shoe 910, for example. Fence 930 may square to Bottom Mount Shoe 910. Fence 930 may include Fence Rest 940 for hanging or securing onto a structure or object. Fence Rest 940 may provide a stable index when resting against a structure or object.

In another embodiment, Fence 930 may couple to a top mount shoe, which may provide clearance to allow Device Component 1210 to function.

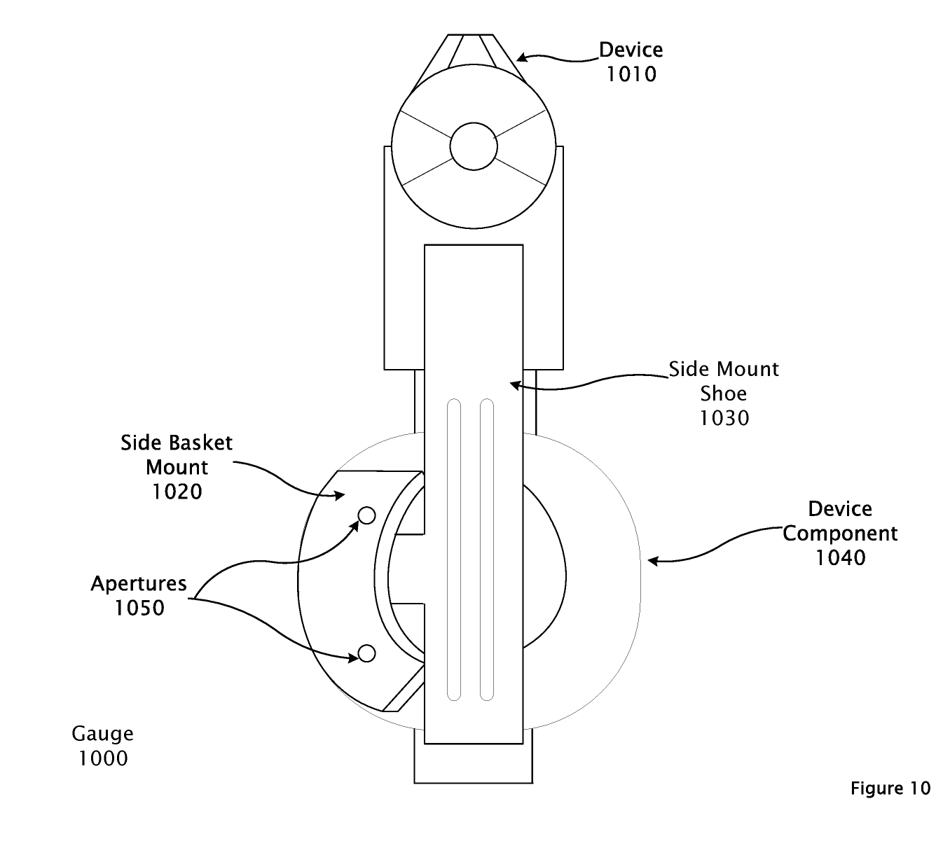

FIG. 10 is a front view of a gauge, according to one embodiment. Gauge 1000 may be secured to a Device 1010, for example, a nailer or fastening gun. Gauge 1000 may comprise Side Basket Mount 1020, which may secure to Device Component 1040, for example, a basket of a nailer or fastening gun. Side Basket Mount 1020 may include Apertures 1050 through which fastening means may secure Side Basket Mount 1020 or Side Mount Shoe 1030 to Device Component 1040 or Device 1010. Apertures 1050 may have any shape or size, and the fastening means may comprise any means such as inserts, perches, backing plates, bushings, or washers. In another embodiment, Side Basket Mount 1020 may be disposed on a bottom side of Device Component 1040, for example, at the bottom of a nailer or fastening gun basket. In yet another embodiment, the gauge may be mounted on a nose of a device.

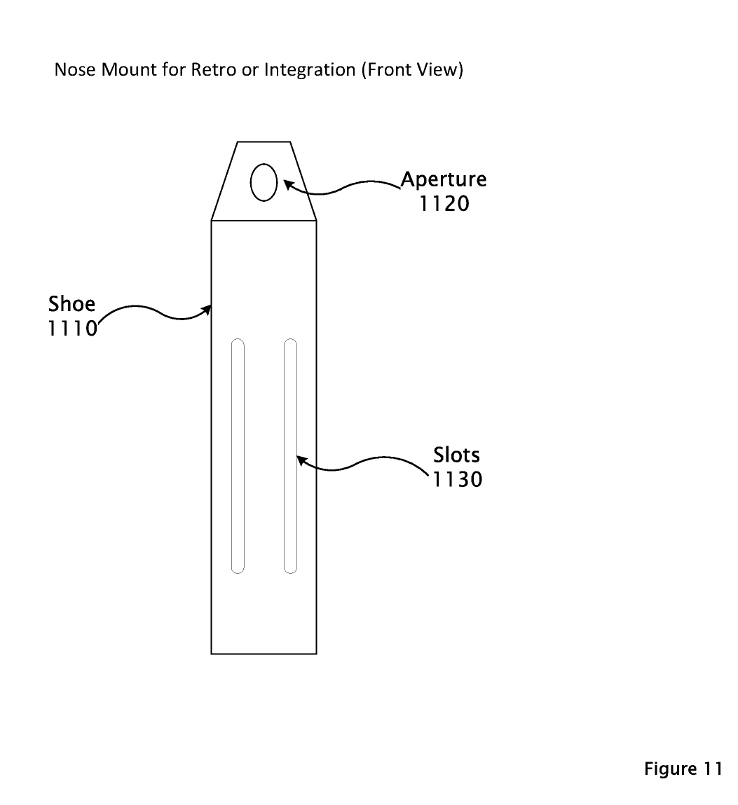

FIG. 11 is a front view of a nose mount for a gauge, according to one embodiment. The nose mount may be operable to retrofit to or be integrated into a device, which may allow a gauge to be attached. Shoe 1110 may allow fastening to a device. Slots 1130 may receive a fence, which may be movable along Slots 1130.

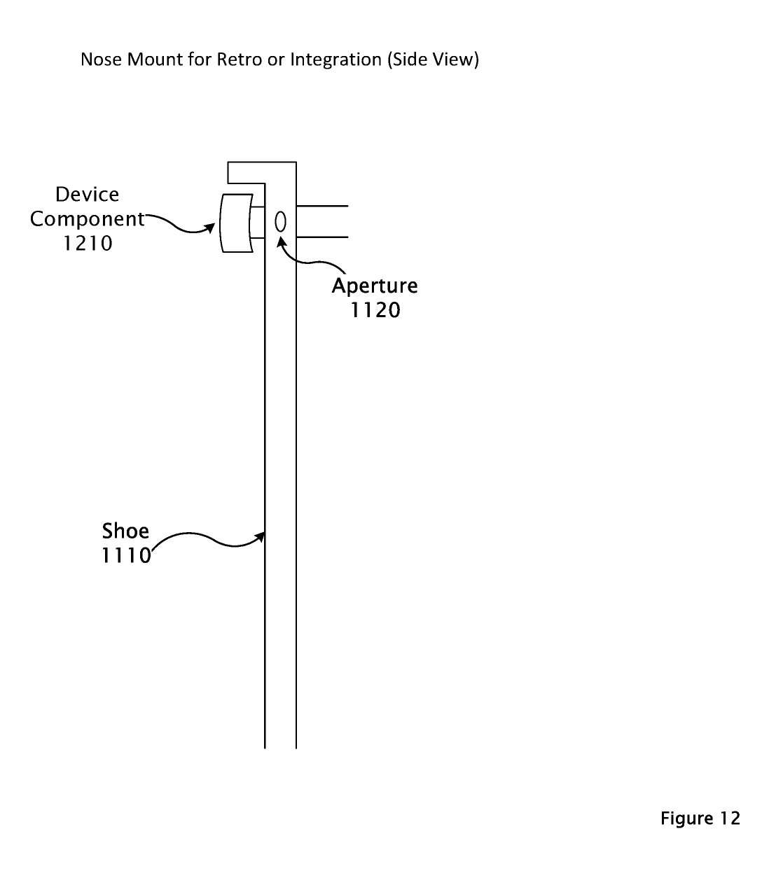

FIG. 12 is a side view of a nose mount for a gauge, according to one embodiment. The nose mount may be operable to retrofit to or be integrated into a device, which may allow a gauge to be attached. Shoe 1110 may allow fastening to a device. Shoe 1110 may attach to a device by using a fastening means, a set screw for example, through Aperture 1120, to attach to Device Component 1210.

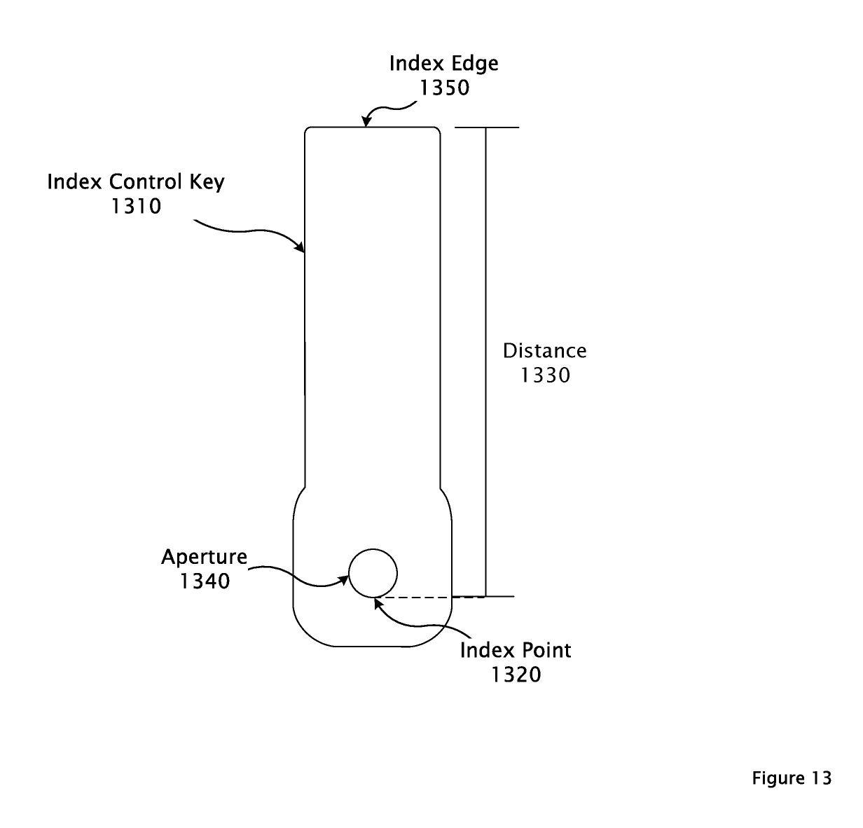

FIG. 13 is a front view of an index control key for a gauge, according to one embodiment. Index Control Key 1310 may be used to set a distance from one Index Point 1320 to another when coupling a gauge to a device, for example. A desired Distance 1330 may be set from an apex, or top arch, of Aperture 1340 to an opposing end of Index Control Key 1310, for example, to Index Edge 1350. The apex of Aperture 1340 may represent a top of a nose of a device. The opposing end of Index Control Key 1310 may represent an edge of a fence of a gauge, for example.

In one embodiment, Index Control Key 1310 may be fitted around a nose of a device. For example, a user may pull down slightly in a direction of a fence of a gauge to remove relative play in the nose of the device. The fence may be slid to an Index Edge 1350 of Index Control Key 1310 and secured in place. A distance may be changed between index points. Index Control Key 1310 may serve as a setup tool or gauge for setting a consistent distance from the device nose to the fence of the gauge. This may provide a more consistent means for setting multiple devices being used in a same task, while offering consistency over holding a tape measure, for example.

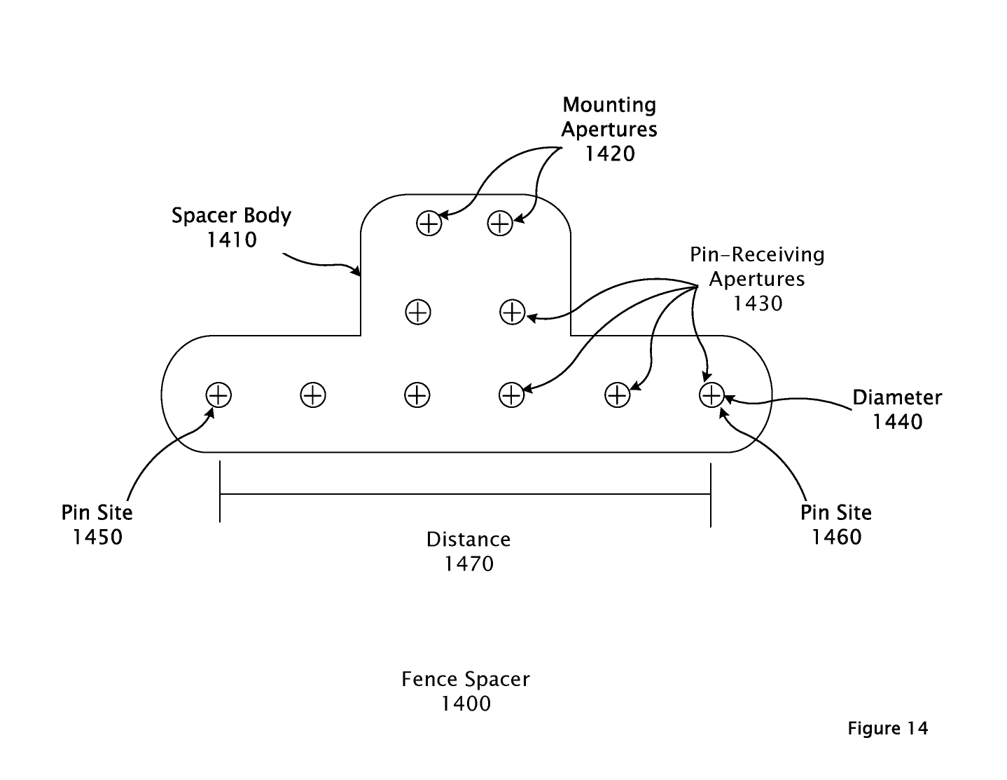

FIG. 14 is a front view of a fence spacer for a gauge, according to one embodiment. Fence Spacer 1400 may comprise an accessory mountable onto a gauge for fencing installation projects. Spacer Body 1410 may comprise a sheet of material, for example, 3/16 inch aluminum, cut in an inverted T-shape, or another shape or material. Spacer Body 1410 may define Mounting Apertures 1420 through which fasteners may secure Spacer Body 1410 to an upper or lower end of a shoe of the gauge. In one implementation, a first Spacer Body 1410 may secure to an upper end of the shoe, and a second Spacer Body 1410 may secure to a lower portion of the shoe. For example, a pair of Spacer Body 1410 may secure to the upper and lower Apertures 380 of the shoe in FIG. 3, or a similar shoe.

Spacer Body 1410 may define a plurality of Pin-Receiving Apertures 1430 to receive pins or other notions. Pin-Receiving Apertures 1430 may fit standard nail sizes, for example, each may have a Diameter 1440 of 0.257 inches. Pin Site 1450 and Pin Site 1460 may be disposed 180 degrees from each other.

In one implementation, a first pin may secure to Pin Site 1450 and a second pin may secure to Pin Site 1460 on a first Spacer Body 1410 which is secured to an upper end of the shoe. Similarly, a first pin may secure to Pin Site 1450 and a second pin may secure to Pin Site 1460 on a second Spacer Body 1410 which is secured to a lower end of the shoe. The first pin on the upper Spacer Body 1410 may be disposed 90 degrees relative to the first pin on the lower Spacer Body 1410, and the second pin on the upper Spacer Body 1410 may be disposed 90 degrees relative to the second pin on the lower Spacer Body 1410. The pair of Spacer Bodies 1410 may work in tandem to create two points of contacts created by the two “left-side” pins and two “right-side” pins disposed in the upper and lower fence spacers. The two points of contact may enable a worker to determine a proper spacing distance between two fencing boards while ensuring vertical placement of a board.

For example, a worker may position the two left-side pins against an installed fence board, creating a first point of contact. The worker may then press a left side of an uninstalled fence board against the two right-side pins, which comprise a second point of contact. The uninstalled board may now be properly positioned for nailing, and a desired distance between the two boards may be efficiently achieved.

For example, if a worker is installing a 5.5 inch-wide fence board and desires 5.5 inches of space between boards, Pin Site 1450 and Pin Site 1460 may be disposed a Distance 1470 of 5.25 inches apart, wherein Distance 1470 is measured from center of each pin site aperture. When the worker presses the left-side pins against the right side of an installed board, and presses an uninstalled board against the right-side pins, the desired 5.5 inches of spacing may be achieved between the two boards. (0.25 inch is properly added from two radiuses of Pin Sites 1450 and 1460).

1. A gauge, comprising:
a mount, the mount operable to secure onto a device;
a shoe, the shoe coupled to the mount, wherein the shoe comprises an elongated sheet of material;
a track, the track disposed on the shoe, wherein the track is operable to receive a fence;
a fence, the fence operable to secure to a first side of the shoe; and
a hook.

2. The gauge of claim 1, further comprising a hinge operable to provide access to a component of the device.

3. The gauge of claim 1, wherein the elongated sheet of material further defines an aperture.

4. The gauge of claim 3, wherein the elongated sheet of material defining an aperture is operable to receive a fastening means.

5. The gauge of claim 4, wherein the fastener means are selected from the list containing screws, bolts, nails, pins, knobs, rivets, magnets, latches, levers, cams, knobs, handles, compression or spring-loaded elements, pinch, spring-loaded, threaded inserts, retaining clips and pins, springs, perches, tangs, spring pins, inserts, threaded keys, wedges, shoulder bolts, washers, nylon fasteners, and bungs.
